(19) United States
(12) Patent Application Publication
(10) Pub. No.: US 2025/0018996 A1
(43) Pub. Date: Jan. 16, 2025

(54) ELECTRIC MOTOR AND HANDWHEEL ACTUATOR ASSEMBLY INCOPORATING A MOTOR

(71) Applicant: ZF Automotive UK Limited, Solihull (GB)

(72) Inventor: David Julian Moule, Birmingham (GB)

(21) Appl. No.: 18/765,409

(22) Filed: Jul. 8, 2024

(30) Foreign Application Priority Data
Jul. 10, 2023 (GB) 2310576.0

(51) Int. Cl. B62D 5/04; H02K 1/14; H02K 1/279

(52) U.S. Cl. CPC B62D 5/0409; H02K 1/14; H02K 1/279

(57) ABSTRACT

A motor includes a stator and a rotor. The stator carries a plurality of phase windings and the rotor carries a plurality of magnet poles and is connected to a shaft. The stator has a ferromagnetic material defining a yoke and a plurality of teeth and further includes at least one band of electrically conductive material that encompasses at least a portion of one of the teeth or encompasses at least a portion of the yoke in a region between adjacent teeth and is in direct contact with the tooth. The band provides an electrical path between the band and the portion of the tooth or yoke. The band wraps around upper and lower end regions of the portion of the tooth or yoke and extends axially down the opposing side faces of the tooth or yoke. The band is isolated from any external source of motor drive current.

### RELATED APPLICATIONS

This application claims priority from GB Patent Application 2310576.0, filed 10 Jul. 2023, the entirety of which is hereby incorporated herein by reference.

### TECHNICAL FIELD

This invention relates to electric motors in particular those suitable for use in a handwheel actuator assembly for use in a steer by wire system of a vehicle

### BACKGROUND

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications is in steer-by-wire systems. During normal use, these systems have no direct mechanical link from the hand wheel that the driver moves and the steered wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary electric motor coupled to the steering wheel. The secondary motor provides the driver with the appropriate resistance and feedback in response to specific user inputs at the steering wheel to mimic the feel of a conventional steering system. This secondary motor is connected to a shaft that supports the handwheel through a gearset, and those three parts collectively form a Handwheel Actuator Assembly.

The motors in a steer by wire system are typically constructed with a stator that comprises laminations stacked together in the axial direction. This is both a cost-effective way to manufacture the motors, but also by applying an electrically insulating coating between each lamination in the stack currents are prevented from flowing axially through the stator. This reduces energy losses within the motor that would otherwise result from current flowing axially in the stator. Such a prior art motor construction exhibits a low level of drag torque from the elimination, or severe restriction, of the current that flows axially.

The term drag torque as used in this description means a torque that is generated by the motor when it is rotating that opposes any torque that is applied to drive the motor. The rotor of a motor which has all of its phases open circuit with virtually zero drag torque can be spun with only a small amount of external torque applied, one with a very high drag torque will require an equally high or higher external torque to make the rotor rotate.

In a steer-by-wire system, a malfunction or failure of a portion of the assembly may impair the ability to steer the vehicle. As a result, it is desirable to provide the assembly with structure for providing at least temporary fail-safe operation. US 2006/0042858 A1 discloses steering apparatus including a steering assembly that includes a handwheel actuator. The handwheel actuator includes a steering column for supporting a steering wheel, a gear mechanism and two motors, each for providing a torque to the steering column. Single motor handwheel actuator assemblies are also known.

When the steer by wire system is powered up and functioning correctly, the HWA imposes torque on the shaft carrying the handwheel that resists the driver turning the steering wheel shaft. For much of the operation of the system, the motor or motors within the handwheel actuator operate as a controlled resistance to the driver. This can be used to give the driver a feel for what is happening at the interface between the road wheels and the road surface that has otherwise been lost with the removal of the mechanical link from the handwheel to the road wheels.

It is undesirable for the hand wheel to be able to rotate freely and a small amount of resistance to movement, which the driver can always overcome is always desirable. Preferably, this resistance to motion is either constant or proportional to the handwheel speed to enable a good steer-feel. In the prior art it is known to provide resistance to movement by absorbing energy within the motor drive electronics using a principle known as braking torque. For example, see the disclosure of Hendershot & Miller ISBN 978-0-9840687-0-8, page 507 where they talk about braking torque in a line start PM motor arising from current flowing through an external short circuit A braking torque is created when there is at least one closed circuit through the motor phases in which current generated as the motor rotates will flow. This requires active control of the motor drive circuit to operate-typically close-appropriate phase switches and force the closed circuit in the motor.

The applicants have appreciated that it is desirable that this resistance should be present even if the electrical power is removed from the system. Where the resistance is achieved by application of appropriate currents to the motor, this resistance will be removed in the event of a fault where currents cannot be supplied or generated within the motor. The applicants have also appreciated that it is desirable to have minimum electrical connections to the motor and to avoid the use of auxiliary windings and connected controllers to create the resistance to motion in the event of a fault within the system

### SUMMARY

An object of the present invention is to provide a motor and a handwheel actuator assembly incorporating such a motor that provides a desirable level of resistance to rotation when the motor is not powered.

According to a first aspect the invention provides a motor comprising a stator and a rotor, the stator carrying a plurality of phase windings and the rotor carrying a plurality of magnet poles and being connected to a shaft; and in which the stator comprises a ferromagnetic material defining a yoke and a plurality of teeth and further comprising at least one band of electrically conductive material that encompasses at least a portion of one of the teeth or encompasses at least a portion of the yoke in a region between adjacent teeth and is in direct contact with the tooth, and in which the band provides an electrical path between the band and the portion of the tooth or yoke and in which the band wraps around upper and lower end regions of the portion of the tooth or yoke and extends axially down the opposing side faces of the tooth or yoke and in which the band is isolated from the motor drive circuitry and has no electrical connections to any part of the drive circuit or other electrical supply.

The band may be in direct contact with the portion of the tooth or yoke over some or all of its length.

The band may be uninsulated at least on the side of the band that faces the tooth to provide a direct conductive path between the band and the tooth. The band may be fully free of insulation.

The motor(s) of the invention generates a desirable level of eddy current and hysteresis loss when the rotor is being turned without the motor being under electrical power and therefore offers a relatively high resistance to rotation, achieved from a stack of laminations that are then wrapped in an axial direction with one or more electrically conductive bands. The use of bands of conductive material provides a design that is well suited to high volume manufacture of electric motors, and the bands occupy minimal space within the motor so that the size of the motor does not need to increase in most cases.

The band may pass only once around the entire tooth or a part of the yoke so as to cross the upper and low surfaces of the tooth and both sides or the upper and lower surface of the yoke and both an inner and outer facing side only once. Or the band may comprise an elongate strip that passes round the tooth or portion of the yoke more than once.

In an alternative where the stator comprises a stack of laminations, the band may encompass a portion comprising a subset of the laminations. There may be multiple bands provided with each encompassing a respective subset of laminations.

For example the stator may split into 3 sections in the axial direction, and each one have a band wrapped around them. Within each section the band would then go around the upper and low surfaces of a portion.

The side of the band facing the tooth or yoke may at all regions or substantially all points be in direct contact with the surface of the tooth or yoke. Alternatively at least one region of the band may stand off from the surface of the tooth or yoke.

The band may comprise a strip of material shaped to provide a flat top part, opposing flat side parts and a flat bottom part. The width of the strip forming the band when measured in a circumferential direction of the stator may be at least 5 times the thickness of the band measured in a radial direction of the motor.

The stator may comprise a stack of laminations and the band may comprise a steel band or from a material which is coated with an electrically conductive material that presents corrosion due to contact with a dissimilar material.

The band may be welded into position relative to the tooth or yoke.

The band could be welded at one or more positions to one or more of the stator laminations to ensure a positive electrical contact or may be a tight fit around the tooth or yoke. This advantageously amplifies the conductive effect of the band as electric currents may now also flow from one electrically conductive lamination to another.

The band could be registered on the stator with indents in the tooth, and if made from steel not degrade the magnetic flux carrying capacity substantially

Optionally the band could be pressed after initial assembly to ensure it is contacting the stator laminations and not ‘barrelling’

The laminations may be coated with an insulating material or may not be coated with an insulating material.

The stator can be made using standard lamination stamping—the band can be an added-on allowing tooling to be re-used and the band only added for applications where damping is necessary.

The motor may comprise a stator that comprises laminations of lossy steel that does not meet the loss (W/kg) requirements of the M470-50A standard.

The steel may comprise a low silicon content steel, and may have less than 1 percent silicon by weight

An example of a steel that may be used to form a plate of the stator of the handwheel actuator assembly of the invention in which the drag torque is generated predominantly due to eddy current losses is a free machining mild steel such as ENIA or ASTM 1215.

An example of a steel that may be used to form a stator of the handwheel actuator assembly of the invention in which the drag torque is generated predominantly due to hysteresis losses is a C75 carbon spring steel which may be provided in the form of 0.5 mm thick sheets.

The steel stator material may have at least 20 times the coercivity, or at least 30 times the coercivity of electrical steel such as M470-50A.

The material from which the stator is manufactured may have a specific total loss when excited with a sinusoidal flux density of amplitude 1 Tesla and frequency of 50 Hz greater than 30 W/kg, when tested according to the ASTM standard A927/A927M-11 (Standard Test Method for Alternating-Current Magnetic Properties of Toroidal Core Specimens Using the Voltmeter-Ammeter-Wattmeter Method).

The motor stator may be configured such that the motor stator assembly excluding copper windings has an effective loss per mass of at least 30 Watts per kg. This is a figure that is greater than any standard electrical steel as used in electrical machines and particularly existing automotive electric assisted steering assemblies.

The motor may be configured to provide at least 60 percent of the resistance to rotation of the output shaft for at least one speed in the range, or at least 70 percent, or 80 percent, or substantially all of the drag torque over a range of non-zero rotational speeds. The motor may provide all or substantially all of the resistance to rotation of the output shaft, by which we mean at least an order of magnitude larger than any resistance provided by mechanical friction present in the motor.

The motor may be configured to provide at least 2 Nm of drag torque over a substantial range of non-zero rotational speeds of the output shaft taking account of gearing between the motor and the output shaft where provided

The drag torque of the motor may provide at least 60 percent, or at least 70 percent or higher of the resistance to rotation of the shaft at 180 degrees/second speed of rotation of the shaft. It may provide all or substantially all of the resistance to rotation of the shaft, by which we mean at least an order of magnitude larger than any resistance provided by mechanical friction present.

In accordance with a second aspect of the present invention, there is a mechanical assembly comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which the stator of at least one of the motors comprises a ferromagnetic material defining a yoke and a plurality of teeth, and further comprising at least one band of electrically conductive material that encompasses at least one of the teeth or encompasses the yoke in a region between adjacent teeth, and in which the band wraps around upper and lower end regions of the portion of the tooth or yoke and extends axially down the opposing side faces of the tooth or yoke.

The band may be uninsulated at least on the side facing the tooth to provide an electrical path between the band and the tooth and in which the band wraps around upper and lower end regions of the tooth or yoke and extends axially down the opposing side faces of the tooth or yoke.

The band may be isolated electrically from any motor drive circuit so that it cannot receive any motor drive currents.

The mechanical assembly may include a gearbox comprising a first gear fixed relative to the shaft and a second gear fixed relative to the output of the motor, rotation of the first gear causing a rotation of the second gear.

The two gears may be directly meshed or may be connected to each other through a belt. Where the mechanism is part of a handwheel actuator assembly, the handwheel actuator may comprise a second gear connected to and configured to rotate with the shaft; and a second motor having an output driving a respective second output gear, the second output gear being engaged with the first gear and hence the shaft.

This second motor may also generate a significant drag torque such that the sum of the drag torque from both motors provides a substantially resistance to the turning of the handwheel when the motor is unpowered.

Alternatively, the second motor may have a more conventional construction using electrical steel as the rotor so that it does not play a significant role in the overall resistance to rotation when unpowered. The first motor may therefore provide considerably more drag torque compared to the second for instance at least double the drag torque.

The motor may comprise a brushless permanent magnet type motor comprising a rotor and a stator having many windings surrounding regularly circumferentially spaced teeth.

The shaft may be connectable to a handwheel directly through a splined connector on an end of the shaft fitting in an internally splined connector of the handwheel. The shaft will therefore rotate at the same speed as the handwheel. The motors if directly connected to the shaft will also rotate at the same speed. If the motors are connected to the shaft through a gearbox, they will rotate at a different speed to the handwheel.

Alternatively, the shaft may be connected to the handwheel through a gearbox. In this case the rotational speed of the shaft may differ from the rotation speed of the handwheel.

The motor may form a part of a handwheel actuator assembly of a steer by wire vehicle in which the motor rotor is connected to a shaft that in turn is connected to a handwheel of the vehicle and the handwheel actuator assembly is configured such that in the event that the control circuit is powered down or disconnected and the handwheel is rotated at 180 degrees per second the combination of motors overall provides a drag torque of at least 50 percent of the resistance to rotation of the shaft and a torque at the handwheel of at least 2 Nm.

The handwheel actuator assembly may comprise two of the motors of the first aspect of the invention, the rotor of each motor being connected to the shaft that in turn is connected to the handwheel.

By providing one or more motors where at least one provides a significant and useful level of drag torque, the driver must apply at least 2 Nm at a handwheel speed of 180 degree/second to maintain a constant speed of rotation of 180 degree/second of the handwheel as that resistance must be overcome before any extra torque is used to accelerate the handwheel. This level of resistance is generally considered acceptable in an automotive handwheel actuator application. If it is too low the steering feels too light and may be too easy to turn at high speeds comprising stability, but if too high it may make the steering so heavy the driver may struggle to turn the wheel and manoeuvre the vehicle. When in electrical contact with the stator laminations, the function of the conducting metal coating is to improve conductivity between adjacent laminations such that it approximates the electrical conductivity of a solid magnetic component, such as a stator stack, thereby promoting larger eddy-currents than would normally be the case with insulated laminations in a stack.

The invention provides a damping of an otherwise uncontrolled rotation without electronics, additional mechanical components or complexity that prevents the steering wheel rotating freely when the power is removed, motor disconnected, or under certain fault conditions that render the control unit electrically inoperative. Removing the need to lose energy in the drive circuit, as is known from the prior art, protects the circuit from damage due to heat build-up and moves the heat loss into the motor where it can better be managed.

### BRIEF DESCRIPTION OF THE DRAWINGS

There will now be described by way of example only one embodiment of the present invention with reference to and as illustrated in the accompanying drawings of which:

FIG. 1 shows the key mechanical components of an embodiment of a handwheel actuator assembly according to an aspect of the invention that includes a pair of motors that may each fall within a further aspect of the invention;

FIG. 2 shows another embodiment of a handwheel actuator assembly according to an aspect of the invention;

FIG. 3 shows a general arrangement of an electronic control unit which controls the two motors of a dual motor drive assembly according to a first aspect of the invention;

FIG. 4 shows a layout of a Steer-by-Wire system including a dual motor drive assembly according to a first aspect of the invention;

FIG. 5(a) is a B-H curve plot of flux density, B against Magnetizing force H for a soft steel such as electrical steel;

FIG. 5(b) is a B-H curve plot of flux density, B against Magnetizing force H for a not so soft steel such as carbon steel;

FIG. 6 is a plot showing the B-H curve for a chosen non-electrical steel used in the motors of the embodiments of FIG. 1 and FIG. 2 against the plot for an electrical steel;

FIG. 7 is a plot showing the increase in overall flux from the motors when constructed using the non-electrical steel versus an electrical steel; and

FIG. 8 shows in cross section the configuration of a motor stator and rotor that may be used in the mechanism of FIG. 1;

FIG. 9 shows in cross section an alternative configuration of a motor stator and rotor that may be used in the mechanism of FIG. 1;

FIG. 10 is a partial view of a tooth and surround yoke of the stator of FIG. 8 prior to fixing of the conductive band and then with the band wrapped in place;

FIG. 11 is a partial view of a tooth and surround yoke of the stator of FIG. 9 prior to fixing of the conductive band and then with the band wrapped in place around the yoke with an optional band also around the tooth.

### DESCRIPTION

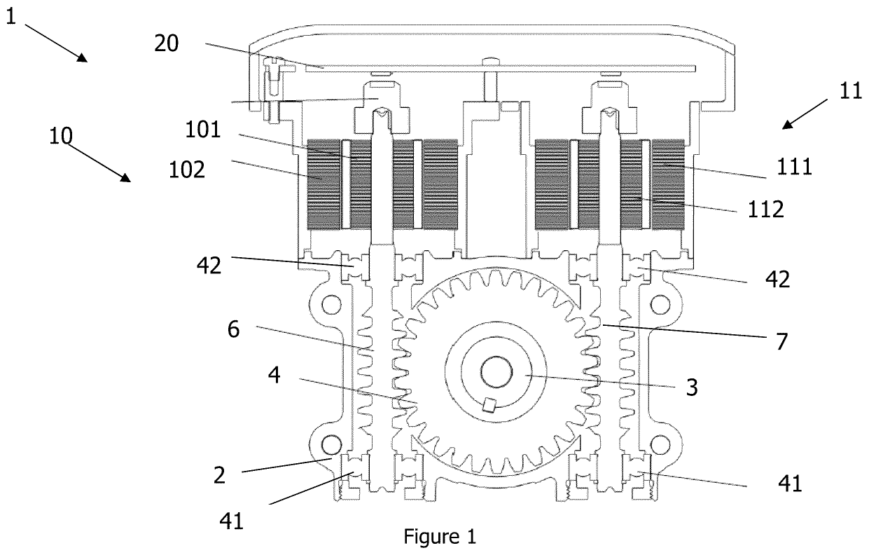

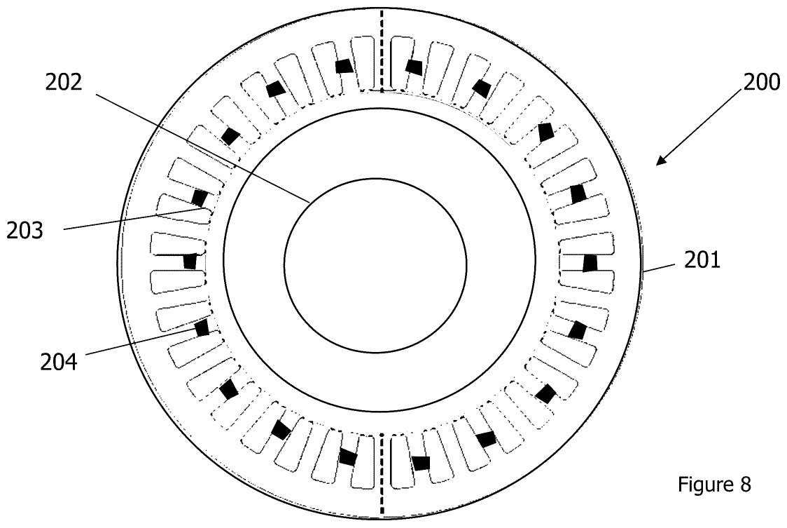

FIG. 1 shows a handwheel actuator (HWA) assembly of a vehicle, according to a first aspect of the invention. This example is a dual motor assembly which has two motors, each connected to a common shaft through a respective gearbox. The invention can be implemented with a single motor and also without the presence of a gearbox by direct connection of the motor rotor to the shaft. The motors have special properties and embody the first aspect of this invention and examples of the motor construction are presented in FIGS. 8 to 11. By describing the motors in relation to one potential use in a handwheel actuator assembly the benefits of these motors over conventional motors in such applications can be readily understood.

The assembly 1 includes a first motor 10 with rotor 101 and stator 102 and a second motor 11 with rotor 111 and stator 112, the first motor 10 being connected to a first worm gear 6 and the second motor 11 being connected to a second worm gear 7. Each worm gear 6, 7 comprises a threaded shaft arranged to engage with a gear wheel 4 connected to a steering column shaft 3 such that torque may be transferred from the worm gears 6, 7 to the gear wheel 4 connected to the steering column shaft 3. The gear wheel 4 is operatively connected to a driver's handwheel (not shown) via the steering column shaft 3. In this example, each of the two motors 10, 11 are brushless permanent magnet type motors and each comprise a rotor 101, 111 and a stator 102, 112 having many windings surrounding regularly circumferentially spaced teeth. The arrangement of the two motors 10, 11, the shaft 3, the worm gears 6, 7 and the wheel gear 4 together form a dual motor electrical assembly.

Each of the two motors 10, 11 are controlled by an electronic control unit (ECU) 20. The ECU 20 controls the level of current applied to the windings and hence the level of torque that is produced by each motor 10, 11.

In this example, the two motors 10, 11 are of a similar design and produce a similar level of maximum torque. However, it is within the scope of this disclosure to have an asymmetric design in which one motor 10, 11 produces a higher level of torque than the other 10, 11.

One of the functions of a handwheel actuator (HWA) assembly is to provide a feedback force to the driver to give an appropriate steering feel. This may be achieved by controlling the torque of the motors 10, 11 in accordance with signals from the handwheel actuator (such as column angle) and from other systems in the vehicle (such as vehicle speed, rack angle, lateral acceleration and yaw rate).

The use of two motors 10, 11 is beneficial in eliminating rattle. If a single electric motor were instead used in a torque feedback unit, the motor may be held in locked contact with the gearing by means of a spring. However, in certain driving conditions the action of a spring is not sufficiently firm, which allows the gears to “rattle” during sinusoidal motions or sharp position changes of the steering column.

Use of two motors 10, 11 which can be actively controlled (as in the present embodiment) ameliorates the problems associated with use of a single motor. In this arrangement, both motors 10, 11 are controlled by the ECU 20 to provide torque feedback to the steering column and to ensure that the worm shafts 6, 7 of both motors 10, 11 are continuously in contact with the gear wheel 4, in order to minimise rattle. The use of two motors 10, 11 in this way also allows active management of the friction and thereby the feedback force to the driver.

As shown in FIG. 1, the motors 10, 11 are received in and secured to a transversely extending two-part extension of a housing 2. The worm shaft 6, 7 of each motor is supported relative to the housing by two sets of bearings. A first set of bearings 41 supports a first end of each worm shaft 6, 7 distal their respective motor 10, 11 while a second set of bearings 42 supports a second end of each worm shaft 6, 7 proximal their respective motor 10, 11.

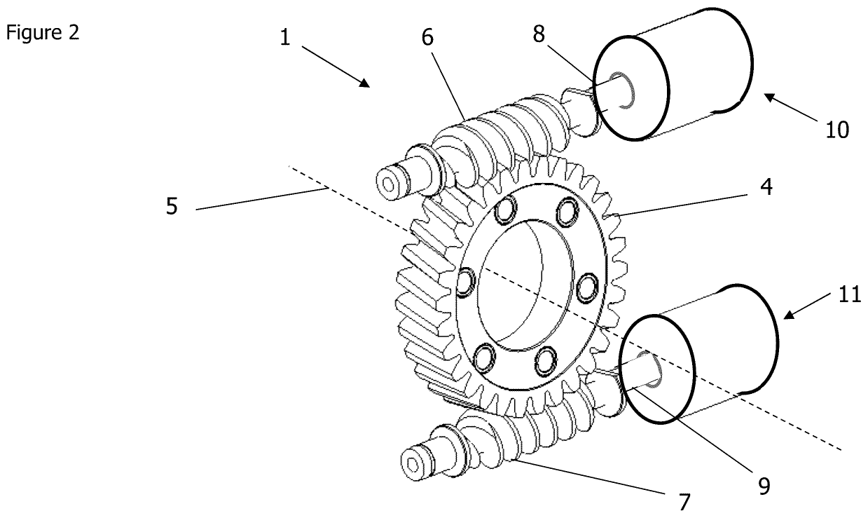

FIG. 2 shows an axis of rotation of the shaft 3 marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to the output shaft 8, 9 of a respective electric motor 10, 11.

The axes of the output shafts 8, 9 of the two motors 10, 11 are arranged perpendicularly to the rotational axis of the shaft 3 and the axes of the two motors may also be inclined with respect to each other, to reduce the overall size of the assembly.

The motors 10, 11 are controlled by the electronic control unit (ECU) 20 such that at low levels of input torque applied to the shaft 3 by the handwheel, the motors 10, 11 act in opposite directions on the gear wheel 4 to eliminate backlash. At higher levels of input torque applied to the shaft 3 by the handwheel, the motors 10, 11 act in the same direction on the gear wheel 4 to assist in rotation of the shaft 3. Here, a motor 10, 11 acting in ‘a direction’ is used indicate the direction of torque applied by a motor 10, 11 to the gear wheel 4.

The use of two separate motors 10, 11 which can be controlled in a first operational mode to apply torque in opposite directions to the gear wheel 4 eliminates the need to control backlash with precision components. In addition, the use of two separate motors 10, 11 which can be controlled in a second operational mode to apply torque in the same direction to the gear wheel 4 allows the motors 10, 11 and gear components 4, 6, 7 to be specified at half the rating of the required total system torque, thereby reducing the size and cost of the drive assembly 1.

In the embodiment shown in FIGS. 1 and 2, the worm shafts 6, 7 engage diametrically opposed portions of a gear wheel 4. The threads of the worm shafts 6, 7 each have the same sense, i.e., they are both left-handed screw threads. The motors 10, 11 are configured such that they lie on the same side of the gear wheel 4 (both motors 10, 11 lie on one side of a virtual plane perpendicular to axes of the worm shafts 6, 7 and passing through the centre point of the gear wheel 4). Considering as an example the perspective shown in FIG. 2, driving both motors 10, 11 clockwise would apply torque in opposite directions to the gear wheel 4, with motor 10 applying a clockwise torque to gear wheel 4 and motor 11 applying an opposing anti-clockwise torque to gear wheel 4.

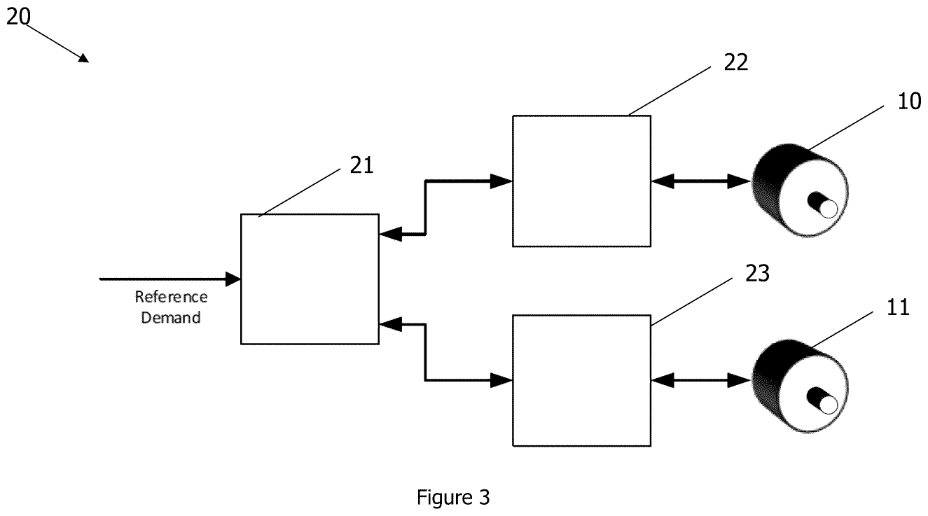

FIG. 2 shows another embodiment of a handwheel actuator assembly 1 according to the first aspect of the invention. This embodiment is substantially similar to the embodiment shown in FIGS. 1 and 2 with the only difference being the positioning of the motors 10, 11. Components and functional units which in terms of function and/or construction are equivalent or identical to those of the preceding embodiment are provided with the same reference signs and are not separately described. The explanations pertaining to FIG. 1 therefore apply in analogous manner to FIG. 3 with the exception of the positioning of the two motors 10, 11.

In FIG. 2 the worm shafts 6, 7 engage diametrically opposed portions of a gear wheel 4 and threads of the worm shafts 6, 7 each have the same sense, i.e., in this example, they are both right-handed screw threads. The motors 10, 11 are configured such that they lie on opposing sides of the gear wheel 4 (motor 10 lies on one side of a virtual plane perpendicular to axes of the worm shafts 6, 7 and passing through the centre point of the gear wheel 4 while motor 11 lies on the other side of this virtual plane).

Application of torque by a driver in a clockwise direction results in rotation of the handwheel 26 and the steering column shaft 3 about the dashed line 5. This rotation is detected by a rotation sensor (not shown). The first motor 10 is then controlled by the ECU 20 to apply torque in the opposite direction. In a first operational mode, the second motor 11 is actuated by the ECU 20 to apply an offset torque 32 in the opposite direction to the torque 30 of the first motor 10 to reduce gear rattling. Alternately, in a second operational mode, the second motor 11 is actuated by the ECU 20 to apply a torque 34 in the same direction to the torque 30 of the first motor 10 to increase the feedback torque to the steering column shaft 3

The net result of the torques by the first and second motors 10, 11 results in an application of a feedback torque to the steering column shaft 3 and handwheel 26, to provide a sensation of road feel to the driver. In this example, the application of a feedback torque is in the opposite direction to that applied to the handwheel 26 by the driver. In this way, the “rattle” produced between the worm shafts 6, 7 and the gear wheel 4 can be eliminated or significantly reduced.

FIG. 3 reveals part of an HWA assembly 80 showing a general arrangement of an electronic control unit (ECU) 20 which controls each of the two motors 10, 11. The ECU 20 may include a hand wheel actuator (HWA) control system 21 as well as a first and second motor controller 22, 23 which control the first and second motors 10, 11 respectively. A reference demand signal is input to the HWA control system 21 which allocates torque demands to each of the first and second motors 10, 11. These motor torque demands are converted to motor current demands and transmitted to the first and second motor controllers 22, 23. Each motor 10, 11 provides operating feedback to their respective motor controller 22, 23. The HWA control system 21 is configured to calculate the magnitude of mechanical friction using the motor torque demands. In another embodiment, the HWA control system 21 may be implemented by a separate ECU to the first and second motor controller 22, 23.

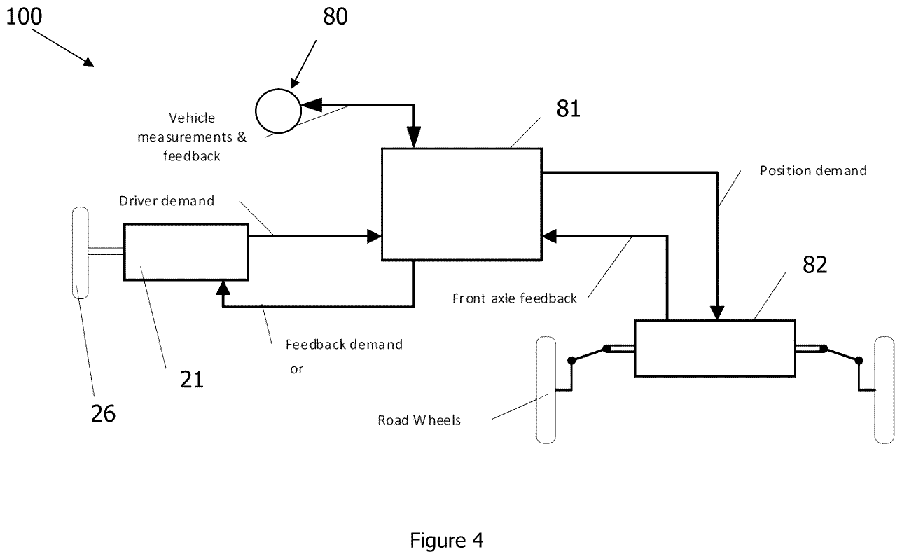

FIG. 4 shows an overall layout of a Steer-by-Wire system 100 for a vehicle including the handwheel actuator (HWA) assembly 80 according to a first aspect of the invention. The HWA assembly 80 supports the driver's handwheel 26 and measures the driver demand which is usually the steering angle. A steering controller 81 converts the driver demand into a position demand that is sent to a front axle actuator (FAA) 82. The FAA 82 controls the steering angle of the roadwheels to achieve the position demand. The FAA 82 can feedback operating states and measurements to the steering controller 81.

The steering controller 81 combines the FAA 82 feedback with other information measured in the vehicle, such as lateral acceleration, to determine a target feedback torque that should be sensed by a driver of the vehicle. This feedback demand is then sent to the HWA control system 21 and is provided by controlling the first and second motors 10, 11 with the first and second motor controllers 22, 23 respectively.

FIG. 4 shows the steering controller 81 as physically separate to both the HWA controller 21 and the FAA 82. Alternately, different architectures, where one or more of these components are physically interconnected, may be used within the scope of this disclosure. For example, the functions of the steering controller 81 may be physically implemented in the HWA controller 21, the FAA 82, or another control unit in the vehicle, or some combination of all 3. Alternatively, control functions ascribed to the HWA controller 21 and FAA 82 may be partially or totally implemented in the steering controller 81.

In the event that there is a fault in the motor windings that prevents any current flowing through the motor, or disconnection of motor from the control electronics, or in the motor drive stage or in the control system, including a loss of electrical power to the handwheel assembly, it becomes impossible to control the rotation of the handwheel by the driver in order to provide feedback. The motors of the handwheel actuator assembly of FIG. 1 are configured in order to ensure that there is some damping of the rotation of the wheel in this condition. This is beneficial as it will feel more natural to the driver and will also help them not make steering inputs at too high a rate by damping their actions.

In a conventional prior art Handwheel actuator assembly the motor is fabricated using a high-performance electrical steel for the stator as it is generally desirable to reduce the level of drag torque and the resulting energy losses. Further reductions are attained by the use of a laminated stator in which electrical steel plates are held apart by interleaved layers of insulating material.

In the embodiment of FIG. 1 and the embodiment of FIG. 2 the two motors are the same and each is configured to provide a substantial level of drag torque when a driver rotates the motor in an unpowered condition by rotating the handwheel. This ensures the handwheel does not spin freely in the event of a fault that removes power from the motor or where the motor has an internal fault that means the current in the windings does not generate any motoring torque in the motor. An added benefit is that more energy is consumed within the motor compared with a low drag torque motor and so there is less for the electronics to do to provide a controlled resistance, heat being dissipated within the motor rather than from the electronics

The skilled person will understand that the invention can be implemented with only one of the motors providing a substantial drag torque and the other a conventional motor used in prior art handwheel actuators with a low drag torque.

By drag torque we mean the torque arises due to energy conversion within the stator of the motor as it is rotating. Mechanical energy from the driver causes the rotor to rotate. As it rotates the rotor and stator interact magnetically generating a changing flux within the stator. This will give rise to both eddy currents and hysteresis losses and electrical energy is converted to heat as these currents pass through the resistive material forming the stator. Thus, mechanical energy is converted heat and a drag torque results.

A first construction of a motor 200 which can be used as one or both of the motors 1,11 of FIG. 1 and FIG. 2 is shown in plan view in FIG. 8. The motor 200 comprises a rotor 202 and a stator 201. The stator 201 comprises a circular yoke 201a and has a set of teeth 203 which each project radially away from the yoke. Each tooth extends axially down the stator from an upper end to a lower end. The rotor 202 fits within a void defined by the tips of these teeth 203 and has an axis that is common with the axis of the stator yoke. The rotor carries a set of permanent magnets.

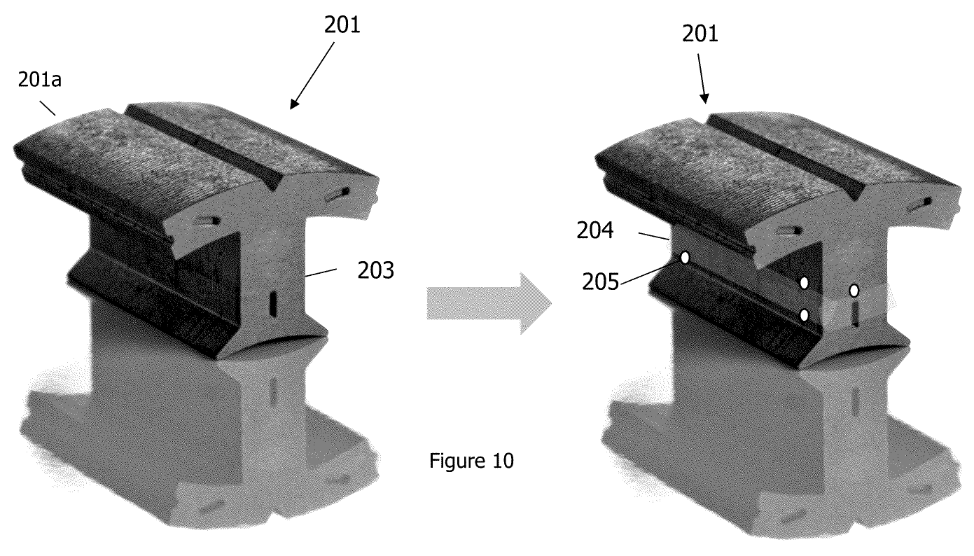

The stator in this example comprises a stack of laminations in the form of metal plates that may be stamped or otherwise cut out of a large metal sheet. In FIG. 10 the top lamination can be seen and several edges of the remaining laminations can also be seen. The laminations are packed tightly together. An insulating coating may be provided on the surface of each lamination to help prevent corrosion of the metal plates.

In this example a band 204 is provided around every other tooth 203 but the invention is not limited to this ratio of bands to teeth. Every tooth 203 may be wrapped with a band 204, or every third or fourth tooth and so on up to having as few as only two diametrically opposed bands.

Each metal band 204 comprises an endless loop passes around a respective tooth of the stator. The band could be formed in a number of ways. For example, if the tooth is straight and has no “tooth tips” protruding, the band could be stamped and formed using mechanical means. Alternatively the band could be wrapped around the tooth and welded. The exemplary band comprises a strip of material has a width that is multiple times the thickness of the strip. As shown in FIG. 10 each band 204 fits tightly around a tooth 203 so that there is a good degree of mechanical contact between the tooth 203 and the band 204. Because the band 204 is electrically conductive and as shown optionally in contact with the tooth over substantially an entire inner surface it has a beneficial effect of increasing the drag torque of the motor 200 compared with an identical motor with no bands. FIG. 10 also shows a number of optional welds 205 that secure the band in position relative to the tooth 203.

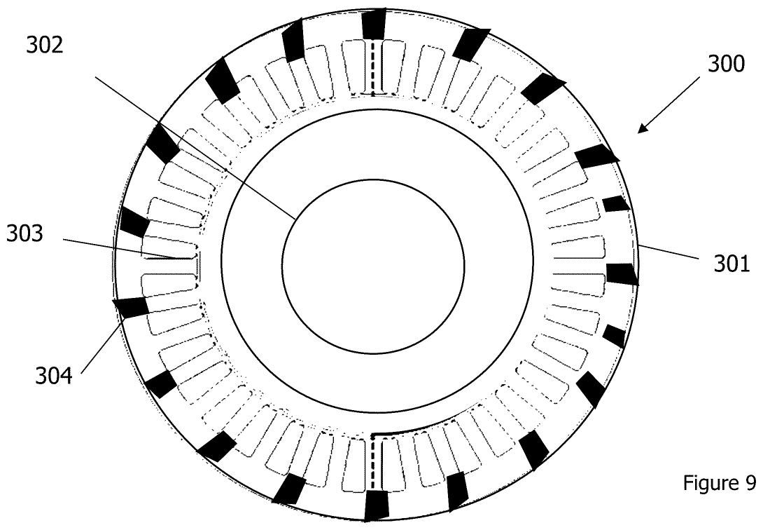

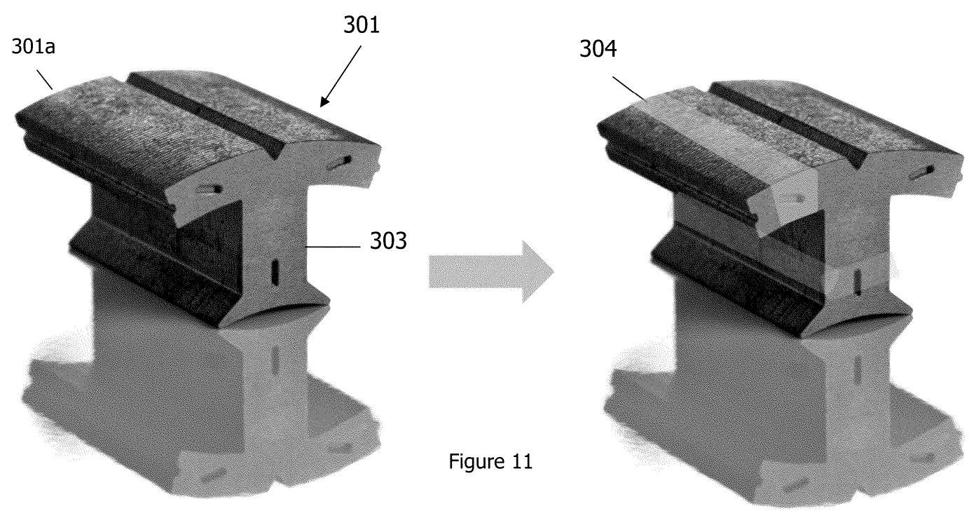

FIG. 9 shows an alternative construction of a motor 300 having a rotor 302 and a stator 301. The stator has a yoke 301a and teeth 303 in which a band 304 is wound around a portion of the yoke 301a rather than a tooth 303. In this arrangement the band 304 is located in the regions of the yoke between adjacent teeth 303. This can be seen in FIG. 11. Also note from FIG. 11 that an optional band around a tooth is also shown.

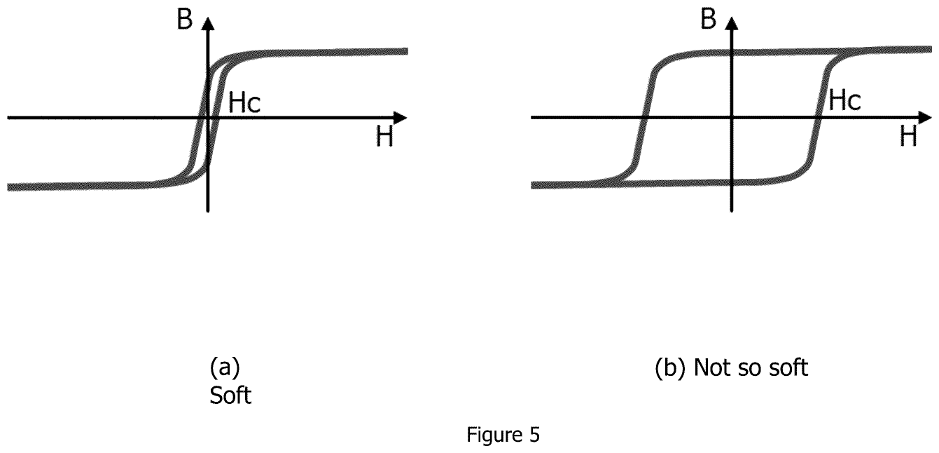

Drag torque arises for several reasons with the two primary reasons being hysteresis within parts of the motor stator and the formation of eddy currents. FIG. 5 illustrates this for a generic soft material such as electrical steel and for a generic not so soft material such as carbon steel that may be used to form the stators in the motors of FIG. 1 or FIG. 2. In each plot the area enclosed represents the loss arising from the magnetic domains reversing—the more times the steel is magnetised north & south, the larger the loss, and therefore the larger the drag torque. Steel with low hysteresis loss performs as shown in FIG. 5(a) and has a narrow hysteresis loop, steel with high hysteresis loss is shown in FIG. 5(b) and has a wider hysteresis loop and a motor fabricated using the later will have more drag torque due to more hysteresis loss.

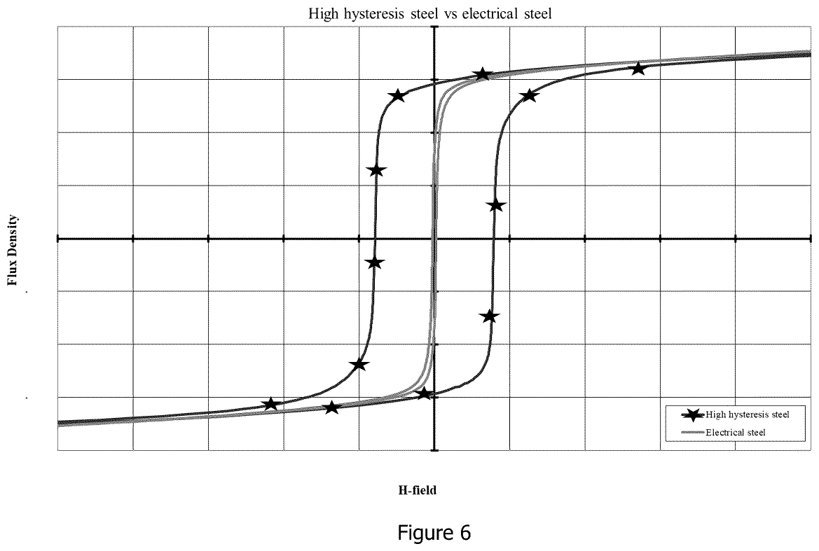

FIG. 6 illustrates the different B-H curves of a high hysteresis steel chosen for the motors of the examples of FIGS. 1 and 2, and additionally FIGS. 9 and 10, and an electrical steel that meets the M470-50 specification. The reference steel is one that falls within the specification of an electrical steel defined. The other is a more lossy steel and not so soft steel such as spring steel. The not so soft steel has considerably more hysteresis. The carbon steel measured in the graph shows approx. 30 times the coercivity and thus much higher drag torque than the electrical steel.

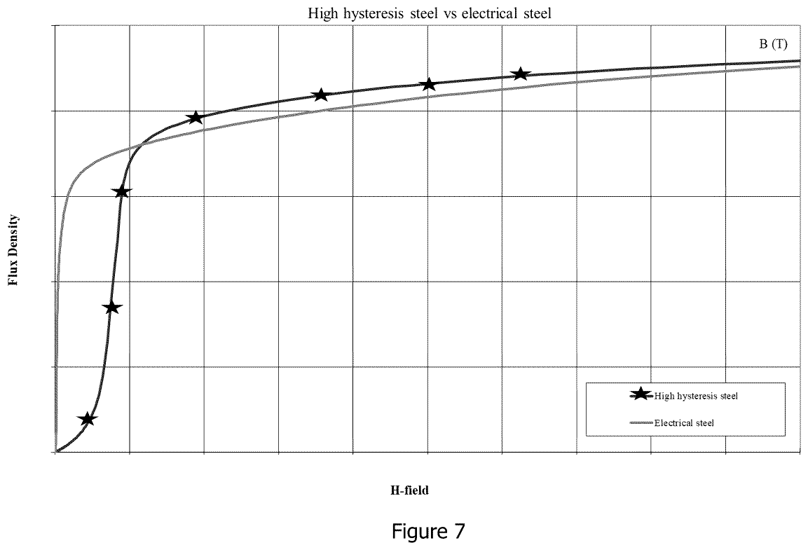

As shown in FIG. 7, the same spring steel at the flux densities of interest within a practical motor reaches at least as high flux density as the electrical steel, giving similar motor performance.

1. A motor comprising a stator and a rotor, the stator carrying a plurality of phase windings and the rotor carrying a plurality of magnet poles and being connected to a shaft; and
in which the stator comprises a ferromagnetic material defining a yoke and a plurality of teeth and further comprising at least one band of electrically conductive material that encompasses at least a portion of one of the teeth or encompasses at least a portion of the yoke in a region between adjacent teeth and is in direct contact with the tooth, and in which the band provides an electrical path between the band and the portion of the tooth or yoke and in which the band wraps around upper and lower end regions of the portion of the tooth or yoke and extends axially down the opposing side faces of the tooth or yoke, and in which the band is isolated from any external source of motor drive current.

2. A motor according to claim 1 in which each band passes only once around the portion of the tooth or a part of the yoke so as to cross the upper and low surfaces of the portion of the tooth and both sides of the portion of the tooth, or pass only once around the upper and lower surface of the portion of the yoke and both an inner and outer facing side only once.

3. A motor according to claim 1 or claim 2 in which the inner surface of the band facing the tooth or yoke is uninsulated and in direct contact with the surface of the tooth or yoke.

4. A motor according to any preceding claim in which the band comprises a strip of material shaped to provide a flat top part, opposing flat side parts and a flat bottom part.

5. A motor according to any preceding claim in which the stator comprises a stack of steel laminations and the band comprises a steel band or another material which is coated with an electrically conductive material that prevents corrosion due to contact with a dissimilar material.

6. A motor according to any preceding claim in which the band is welded into position relative to the tooth or yoke.

7. A mechanical assembly comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which the stator of at least one of the motors comprises a ferromagnetic material defining a yoke and a plurality of teeth and further comprising at least one band of electrically conductive material that encompasses at least a portion of one of the teeth or encompasses at least a portion of the yoke in a region between adjacent teeth and is in direct contact with the tooth, and in which the band provides an electrical path between the band and the portion of the tooth or yoke and in which the band wraps around upper and lower end regions of the portion of the tooth or yoke and extends axially down the opposing side faces of the tooth or yoke, and in which the band is isolated from the control circuit so that it cannot receive current from or cause a flow of current to any external source of current.

8. A mechanical assembly according to claim 7 in which at least one motor includes the features of any one of claims 2 to 6.
